(19) United States
(12) Patent Application Publication
(10) Pub. No.: US 2020/0033450 A1
(43) Pub. Date: Jan. 30, 2020

(54) LIDAR DEVICE AND CHANNEL GATING METHOD THEREOF

(71) Applicants: Surestar Laser Technology (Suzhou) Co., Ltd., Suzhou (CN); Beijing Toolight Technology Co., Ltd., Beijing (CN)

(72) Inventor: Zhiwu Zhang, Beijing (CN)

(21) Appl. No.: 16/589,078

(22) Filed: Sep. 30, 2019

Related U.S. Application Data
(63) Continuation of application No. PCT/CN2018/000123, filed on Mar. 30, 2018.

(51) Int. Cl. G01S 7/481; G01S 17/10

(52) U.S. Cl. CPC G01S 7/4811; G01S 7/4816; G01S 7/4817; G01S 17/107; G01S 7/4815

(57) ABSTRACT

The present invention relates to a LiDAR device and a channel gating method, comprises: a laser emitting device having N semiconductor lasers arranged in an emission array for emitting N emergent light beams; an emission lens group for adjusting angles of the N emergent light beams; a receiving lens group for adjusting an angle of incident light; and a laser receiving device having N photoelectric sensors arranged in a receiving array for receiving incident light adjusted by the receiving lens group. The position of the N semiconductor lasers in the emission array is equal to that of the N photoelectric sensors in the receiving array, the emission lens group and the receiving lens group have corresponding optical paths, and the emergent light from the N semiconductor lasers is reflected off a target and is then incident on the N photoelectric sensors.

### CROSS-REFERENCE TO RELATED APPLICATIONS

This application is a continuation of International Application No. PCT/CN2018/000123, filed on Mar. 30, 2018, which claims priority to Chinese Patent Application No. CN201710213213.6 filed on Apr. 1, 2017, Chinese Patent Application No. CN201710654507.2, filed on Aug. 3, 2017, and Chinese Patent Application No. CN201820228827.1, filed on Feb. 9, 2018, all of which are hereby incorporated by reference in their entireties.

### FIELD OF THE INVENTION

The present disclosure relates to the field of multichannel laser measurement, and in particular to a LiDAR device and a channel gating method thereof.

### BACKGROUND OF THE INVENTION

FIGS. 1 and 2 show a scanning array in a LiDAR of U.S. Pat. No. 8,767,190B2.

In the scanning array, a motherboard 20 is provided on a frame 22. A plurality of emitter panels 30 are sequentially inserted onto the motherboard 20, and a plurality of detector panels 32 are sequentially inserted onto the motherboard 20. The plurality of emitter panels 30 are provided in a vertical direction, and the plurality of detector panels 32 are provided in the vertical direction. An emitter is provided on each emitter panel 30, and a detector is provided on each detector panel 32.

As shown in FIG. 2, the plurality of detector panels 32 are provided in a shape of a fan as a whole, so as to generate a field of view from 10 degrees above a horizontal line to 30 degrees below the horizontal line. The plurality of continuous detector panels are set to be inclined at an angle sequentially, thus distributed sequentially relative to a center axis.

The plurality of emitter panels 30 are provided symmetrically with the plurality of detector panels 32, and also provided in a shape of a fan as a whole, so as to generate a field of view from 10 degrees above the horizontal line to 30 degrees below the horizontal line, and the plurality of continuous emitter panels are set to be inclined sequentially at an angle, thus distributed sequentially relative to a center axis.

### SUMMARY OF THE INVENTION

The present disclosure discloses a LiDAR device, including: a laser emitting device, having N semiconductor lasers arranged in an emission array, for emitting N emergent light beams, the N semiconductor lasers being provided on M emission circuit boards of the laser emitting device, and M being less than N; an emission lens group, configured for adjusting angles of the N emergent light beams; a receiving lens group, configured for adjusting an angle of incident light; and a laser receiving device, having N photoelectric sensors arranged into a receiving array, for receiving the incident light adjusted by the receiving lens group; wherein the position of the nth semiconductor laser in the emission array is equal to that of the nth photoelectric sensor in the receiving array, n=1, 2 . . . N, N is a positive integer, M is a positive integer, and the emission lens group and the receiving lens group have corresponding light paths, such that the emergent light emitted by the nth semiconductor laser is reflected off a target and then incident on the nth photoelectric sensor.

The present disclosure further discloses a channel gating method, including: gating N semiconductor lasers sequentially in a set order, and gating the nth photoelectric sensor correspondingly when the nth semiconductor laser is gated.

The present disclosure further discloses a LiDAR device, including an optical-mechanical structural assembly, a laser ranging module and a 360-degree scanning driver module, wherein the optical-mechanical structural assembly further includes an axis system structure and an optical window, and the axis system structure is a rotation axis of the laser ranging module; the laser ranging module includes an emission lens group, a receiving lens group, a laser emitting device and a laser receiving device; the 360-degree scanning driver module includes a scanning mechanism and a scanning driving and control circuit, a scanning axis of the scanning mechanism is coaxial with the axis system structure, and the scanning mechanism drives the laser ranging module to rotate about the axis system structure to achieve 360-degree laser scanning detection; the laser emitting device has N semiconductor lasers arranged in an emission array, for emitting N emergent light beams, the N semiconductor lasers are provided on M emission circuit boards of the laser emitting device, and M is less than N; the emission lens group is configured for adjusting angles of the N emergent light beams; the receiving lens group is configured for adjusting an angle of incident light; and the laser receiving device has N photoelectric sensors arranged in a receiving array, for receiving the incident light adjusted by the receiving lens group; the position of the nth semiconductor laser in the emission array is equal to that of the nth photoelectric sensor in the receiving array, n=1, 2 . . . N, N is a positive integer, M is a positive integer, and the emission lens group and the receiving lens group have corresponding light paths, such that the emergent light emitted by the nth semiconductor laser is reflected by a target and then incident on the nth photoelectric sensor.

### BRIEF DESCRIPTION OF THE DRAWINGS

FIGS. 1 and 2 show schematic views of a scanning array in a LiDAR of U.S. Pat. No. 8,767,190B2.

FIG. 3A shows a schematic structural view of a LiDAR device according to the present disclosure.

FIG. 3B shows a schematic structural view of a light path of the LiDAR device according to the present disclosure.

FIG. 4 shows a schematic structural view of one embodiment of a laser emitting device according to the present disclosure.

FIG. 5 shows a schematic structural view of another embodiment of the laser emitting device according to the present disclosure.

FIG. 6 shows a schematic structural view of yet another embodiment of the laser emitting device according to the present disclosure.

FIG. 7 shows a schematic structural view of still another embodiment of the laser emitting device according to the present disclosure.

FIG. 8A shows a schematic view of a sequential gating emitting control mode according to the present disclosure.

FIG. 8B shows a schematic view of a sequential gating receiving control mode according to the present disclosure.

FIG. 9 shows an example view of the array laser emitting device and a projection light spot array according to a specific embodiment of the present disclosure.

FIGS. 10 and 17 show schematic structural views of the laser emitting device and the laser receiving device according to the present disclosure.

FIGS. 11 and 11A show schematic arrangement views of semiconductor lasers and photoelectric sensors according to the present disclosure.

FIG. 12 is a schematic top view of the LiDAR device according to the embodiment shown in FIG. 3A.

FIG. 13 shows a schematic structural view of the LiDAR device according to the present disclosure.

FIG. 14 is a schematic top view of the LiDAR device according to the embodiment shown in FIG. 13.

FIGS. 15 and 16 are schematic top views of the LiDAR device according to another embodiment.

FIG. 18 is a schematic structural view of the LiDAR device according to the present disclosure.

FIG. 19 is a schematic view of a different structural frame of an optical-mechanical structural assembly according to the present disclosure.

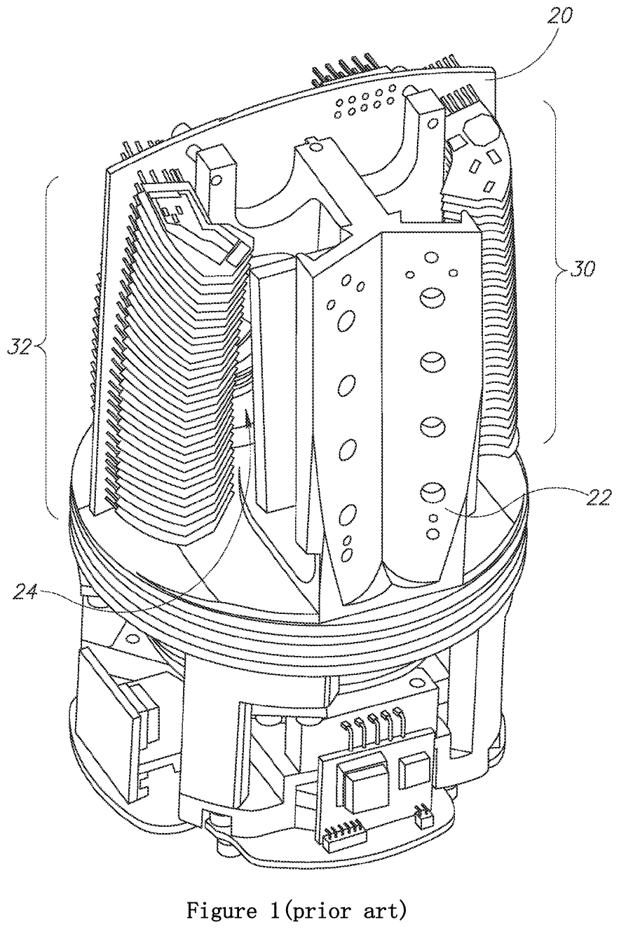

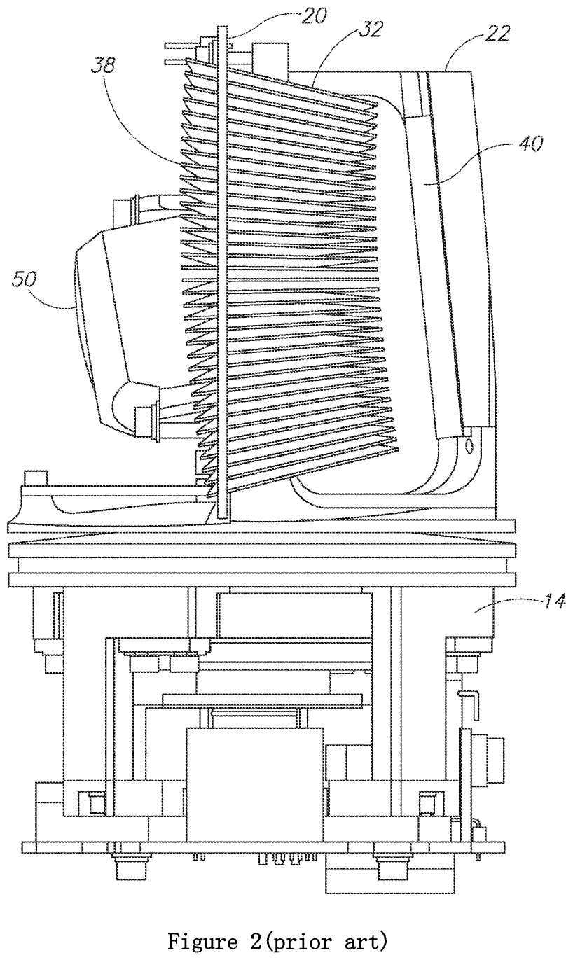

### DETAILED DESCRIPTION OF THE EMBODIMENTS

The technical solution of the embodiments of the present disclosure will be described hereinafter clearly and completely in conjunction with the drawings. Obviously, the following embodiments are merely a part of, rather than all of, the embodiments of the present disclosure. Based on the embodiments of the present disclosure, any other embodiments obtained by a person skilled in the art without any creative effort shall fall within the protection scope of the present disclosure.

Inventor of present disclosure found that when the scanning array in a prior art is mounted, insertion angles of all the emitter panels 30 and all the detector panels 32 relative to the motherboard 20 are required to be corrected individually. In order to obtain an accurate scanning result, in a process of mounting the product in practice, an insertion error of the product must be of a micron level, and a process of adjusting and fixing an angle between two panel surfaces at a specific angle is also complicated. Therefore, the mounting process corresponding to this structure is complicated and has a low production efficiency, high costs, and a low yield.

In addition, in the structure of the scanning array in a prior art, each emitter or detector is required to be provided on one panel individually, and there are a large number of required panels, which increases the weight and the volume of the structure, and is difficult to achieve low costs and miniaturization of an apparatus.

The present disclosure discloses a LiDAR device with a concise mounting process, high efficiency and high yield. Meanwhile, the volume may be reduced, so as to achieve the low cost and miniaturization of the apparatus.

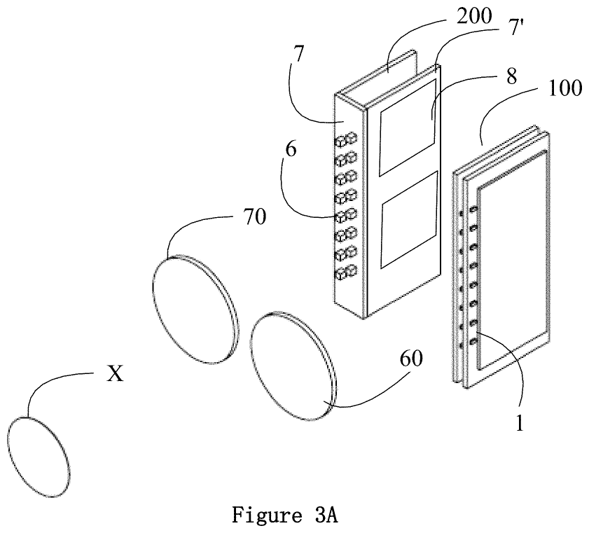

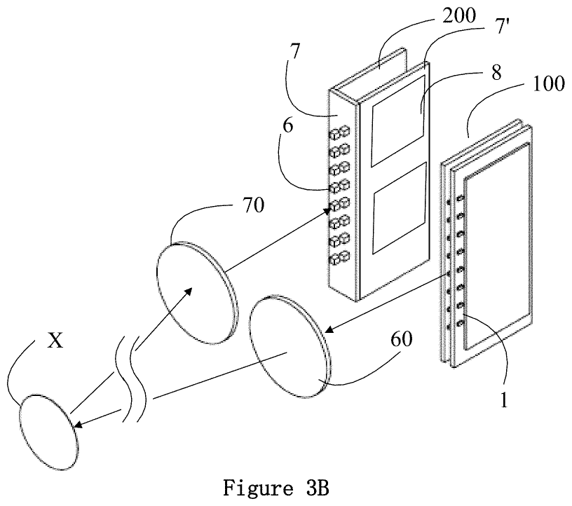

In one embodiment of the present disclosure, FIG. 3A shows a schematic structural view of the LiDAR device according to the present disclosure, in which other well-known structures of the LiDAR device are omitted. The LiDAR device acquires three-dimensional information of a target X in an environment through laser scanning.

The LiDAR device includes a laser emitting device 100, an emission lens group 60, a receiving lens group 70 and a laser receiving device 200.

The laser emitting device 100 has N semiconductor lasers 1 arranged in an emission array for emitting N emergent light beams. The N semiconductor lasers are provided on M emission circuit boards of the laser emitting device 100, and M is less than N. As shown in FIG. 3A, N=16, M=2, but the present disclosure is not limited thereto, and other numbers of semiconductor lasers 1 and emission circuit boards also fall within the disclosed scope of the present disclosure. In the present disclosure, by providing the plurality of semiconductor lasers on the emission circuit board intensively, the number of the emission circuit board is decreased, and the volume is compressed.

The emission lens group 60 is provided in front of the laser emitting device 100 and configured for receiving the N emergent light beams and adjusting angles thereof.

The receiving lens group 70 is arranged side by side with the emission lens group 60 and is arranged in front of the laser receiving device 200, and configured for adjusting an angle of incident light.

The laser receiving device 200 has N photoelectric sensors 6 arranged in a receiving array, for receiving the incident light adjusted by the receiving lens group 70. The number of the photoelectric sensors 6 is consistent with that of the semiconductor lasers 1, and the arrangement of the emission array and the receiving array are also completely the same. That is, the position of the nth semiconductor laser in the emission array is equal to that of the nth photoelectric sensor in the receiving array, n=1, 2 . . . N, and N is a positive integer.

Each semiconductor laser has one photoelectric sensor corresponding thereto, i.e., no matter how the semiconductor lasers are arranged, the photoelectric sensors are arranged in the same way, the emergent light emitted by the nth semiconductor laser is reflected off the target and then incident on the nth photoelectric sensor, and the semiconductor laser and the photoelectric sensor work in cooperation.

Optical parameters of the emission lens group 60 and the receiving lens group 70 are identical, and also the position of the emission array relative to the emission lens group 60 and the position of the receiving array relative to the receiving lens group 70 are identical; as such, the emission lens group 60 and the receiving lens group 70 have corresponding light paths. The emission lens group 60 and the receiving lens group 70 may also obtain the corresponding light paths in other ways, and the present disclosure is not limited thereto.

FIG. 3B shows a schematic view of a light path of the LiDAR device according to the present disclosure. The semiconductor lasers in the emission array are sorted from top to bottom and from right to left, and the photoelectric sensors in the receiving array are also sorted in the same order; as such, the emergent light emitted by the 13th semiconductor laser in FIG. 3B is adjusted by the emission lens group 60, irradiated on and reflected off the target, and then adjusted by the receiving lens group 70 and received by the 13th photoelectric sensor. Other sorting orders also fall within the disclosed scope of the present disclosure, and working modes of the other semiconductor lasers are the same as this.

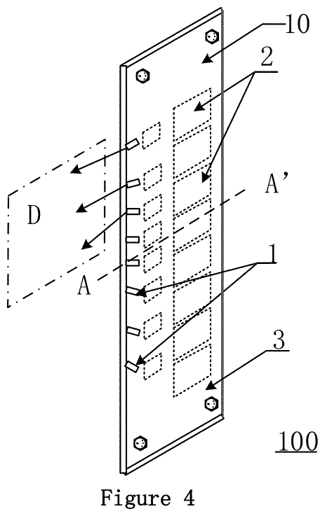

FIGS. 4 to 7 show schematic structural views of the laser emitting device according to the present disclosure.

The laser emitting device 100 according to the present disclosure includes at least one laser emitting module 10 which further includes an emission circuit board 3, a plurality of semiconductor lasers 1 and a driving circuit 2.

The plurality of semiconductor lasers 1 are provided on the emission circuit board 3 sequentially, and the emission circuit board 3 is vertically placed on a horizontal body (not shown); in one optimized embodiment, the plurality of semiconductor lasers 1 are provided at an edge of one side of the emission circuit board 3 sequentially, so as to emit light from the edge of the circuit board.

The driving circuit 2 is connected with the plurality of semiconductor lasers 1 to drive the plurality of semiconductor lasers 1 to emit light. In one embodiment, the same one driving circuit 2 may drive the plurality of semiconductor lasers 1. In another embodiment, each semiconductor laser 1 may be provided with one driving circuit 2 and driven independently.

Bottom surfaces of the plurality of semiconductor lasers 1 are welded to the emission circuit board 3, the light beams are emitted from side surfaces of the plurality of semiconductor lasers 1, i.e., a light outgoing surface D consisting of light outgoing directions of the plurality of semiconductor lasers 1 is parallel to the emission circuit board 3, the light outgoing directions of all the semiconductor lasers 1 are towards the same side of the circuit board, and the light beams are emitted outwards from the edge. In addition, any two emergent light beams adjusted by the emission lens group 60 have different directions.

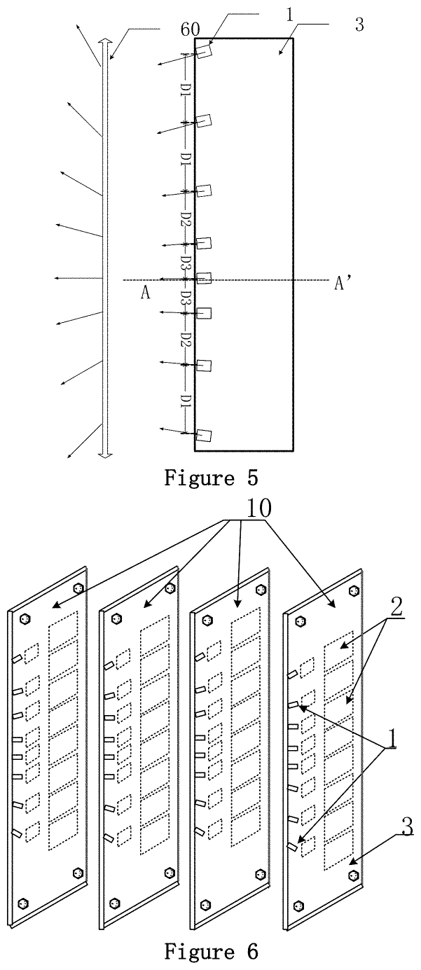

Specifically, as shown in FIG. 5, eight semiconductor lasers 1 and the corresponding driving circuit (not shown in FIG. 5) are arranged on one emission circuit board 3 longitudinally. Laser light emitted by the semiconductor lasers 1 is emitted through the emission lens group 60. The eight semiconductor lasers are arranged from top to bottom and have certain intervals sequentially, and the intervals may be the same or different. For example, the intervals between centers of two adjacent semiconductor lasers 1 may be D1, D1, D2, D3, D3, D2 and D1 respectively, and D1>D2>D3. The light beams of the eight semiconductor lasers are emitted from a left side of the emission circuit board 3 in FIG. 5. After refracted by the emission lens group 60, the laser light beams of the eight semiconductor lasers 1 have different emergent angles relative to an AA′ line, and are sequentially changed by an angle, to form a laser scanning view field angle within a certain angle range, for example, from 20 to 30 degrees, to perform electronic-control array scanning on the target. As such, pointing directions of optical axes and positions of all the semiconductor lasers 1 are different, and each of the semiconductor lasers corresponds to one local emitting view fields respectively. The pointing direction and the position of each semiconductor laser 1 are required to be set with reference to design parameters of laser emitting paths in the emission lens group 60 and the system.

Since the light outgoing surface D consisting of the light outgoing directions of the semiconductor lasers 1 is parallel to the emission circuit board 3, and the plurality of semiconductor lasers 1 are located on the same emission circuit board 3, in the mounting process, in order to adjust the specific light outgoing directions, only the angles of light emitting side surfaces of the semiconductor lasers 1 relative to the AA′ line of the emission circuit board 3 are to be adjusted and welding is performed. The process of adjusting the above angle to a specific angle and fixing at this specific angle is concise, the efficiency is high, the yield is high, and mass production is easy to be realized. Also, since the plurality of semiconductor lasers 1 are located on the same one emission circuit board 3, there is no need to provide one circuit board for each semiconductor laser 1 as in the prior art, which saves lots of emission circuit boards 3, thereby reducing the volume and weight and conveniently achieving the low cost and miniaturization of the apparatus.

As shown in FIG. 6, in another embodiment of the present disclosure, the laser emitting device 10 may further include a plurality of laser emitting modules 10, for example, four laser emitting modules. As shown in FIG. 6, the four laser emitting modules are provided side by side, preferably in parallel, and may also be stacked and fixed together correspondingly. The light outgoing directions of all the semiconductor lasers are towards the same side. The eight semiconductor lasers 1 on each laser emitting module 10 are fixedly arranged on the emission circuit board at different intervals, the emergent light beams of any two of the thirty-two semiconductor lasers 1 have different emergent angles after adjusted by the emission lens group 60, and a 32-line array laser emitting device with 8 rows×4 columns is formed. The angles at which the semiconductor lasers 1 are provided may be adjusted based on parameters of the light path of the emission lens group 60. For example, as shown in FIG. 5, after laser light emitted by each laser emitting module 10 is refracted by the emission lens group 60, the laser emergent angles of the eight semiconductor lasers relative to the AA′ line differ from one another to form a sector, such that the lasers are emitted intensively.

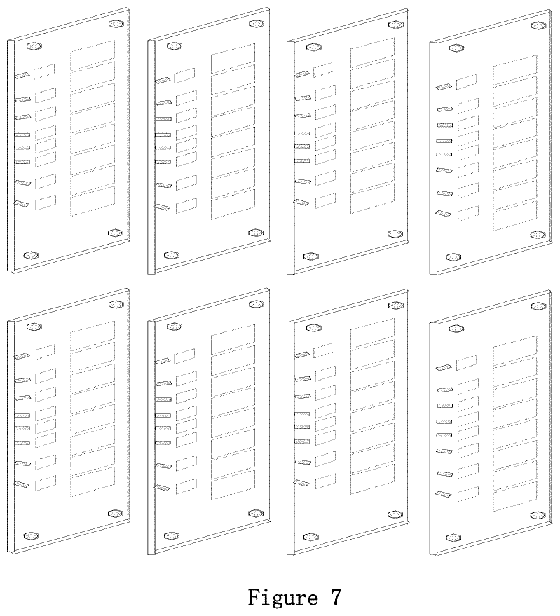

FIG. 7 shows a schematic structural view of the laser emitting device according to still another embodiment of the present disclosure. The laser emitting device 100 includes two rows of laser emitting modules 10 shown in FIG. 6, whose light outgoing directions are towards the same side. Multi-row arrangements with other numbers of rows also fall within the disclosed scope of the prevent disclosure. FIG. 7 shows a 64-line array laser emitting device. The light outgoing directions of any two semiconductor lasers are different, and laser is distributed more intensively.

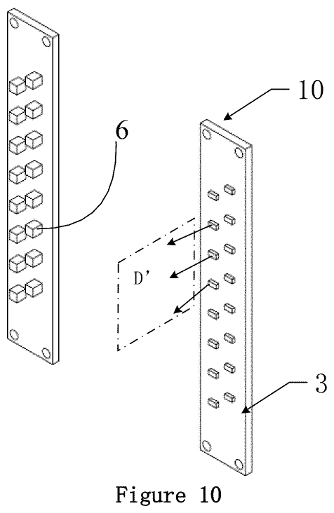

In addition to the arrangement of the laser emitting device 100 in FIG. 3A, the arrangement shown in FIG. 10 is also included and differs from that in FIG. 3A only in that the laser emitting device 100 includes at least one laser emitting module 10 which includes one vertically-placed emission circuit board 3. The N semiconductor lasers are placed on the emission circuit board to constitute the emission array, the light outgoing surface D′ consisting of the light outgoing directions of all the columns in the emission array is perpendicular to the emission circuit board, and the number and arrangement of the optical sensors are the same as those of the semiconductor lasers. Other arrangements are the same as those in the above-mentioned embodiment. Sixteen semiconductor lasers 1 may also be provided on one emission circuit board 3, sixteen photoelectric sensors are provided accordingly, and the volume of the LiDAR device is compressed; meanwhile, different emergent angles of the semiconductor lasers 1 may also be set on one circuit board using semiconductor lasers 1 stated in Chinese patent application CN201720845753.1, such that the mounting process is simple and easy to do, and has a low error. The plurality of laser emitting modules 10 may also be provided side by side, and the semiconductor lasers contained in all the laser emitting modules constitute the emission array.

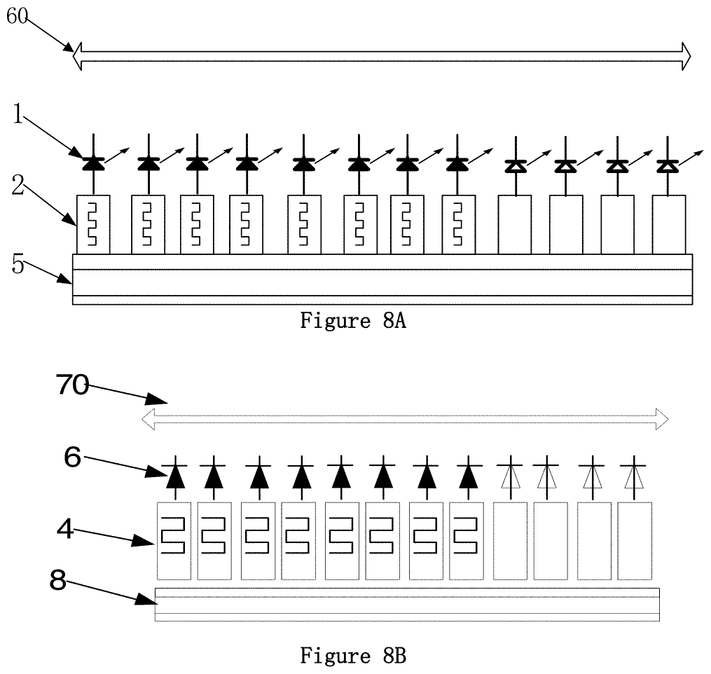

In addition, referring to FIG. 8A, the laser emitting device 100 further includes a laser emission control module 5 connected with all the laser emitting modules 10. The laser emission control module 5 may control one or more semiconductor lasers 1 (LD) and driving circuits 2 thereof, and the driving circuits 2 are controlled according to programming to drive the corresponding semiconductor lasers 1 to emit the lasers sequentially in a predetermined order.

With the array arrangement of the semiconductor lasers 1, the laser emission control module 5 performs time-shared control on all the semiconductor lasers to achieve laser scanning on a target area.

The laser emission control module 5 may be provided on the emission circuit board 3, or the laser emission control module is provided on the control circuit board (not shown) other than the emission circuit board 3, and the control circuit board is connected to the emission circuit board 3 through a connector.

From the above arrangement, it may be known that the mounting process according to the present disclosure is concise, the efficiency is high, the yield is high, and mass production is easy to be realized. Also, in the present disclosure, by means of the circuit integration and electronic control scanning, array laser emitting devices are integrated and miniaturized, which reduces a size and the weight of the system, thereby achieving low costs and miniaturization of the apparatus.

As shown in FIG. 3A, the laser receiving device 200 according to the present disclosure further includes: N photoelectric sensor units, a vertically-placed receiving circuit board 7, and a sensor array control circuit 8.

Each of the N photoelectric sensor units includes the photoelectric sensor 6 and a peripheral circuit thereof (not shown). Each semiconductor laser and the corresponding photoelectric sensor are considered as a channel, and each photoelectric sensor unit is configured for receiving an optical signal and achieving photoelectric signal conversion. The photoelectric sensors of the photoelectric sensor units may be APDs, PINs or other photoelectric conversion detection devices.

The N photoelectric sensors 6 are provided on the vertically-placed receiving circuit board 7, and the peripheral circuit may be provided on the receiving circuit board 7 or an auxiliary circuit board 7′.

The sensor array control circuit 8 is configured for controlling gating of the N photoelectric sensors 6. The sensor array control circuit 8 may be provided on the receiving circuit board 7 or the auxiliary circuit board 7′, or independently provided on a control circuit board (not shown), and the control circuit board is connected to the receiving circuit board 7 through a connector. The sensor array control circuit 8 may control one or more photoelectric sensors and the peripheral circuit thereof, and control the photoelectric sensors according to the programming to be gated in a predetermined order, or the N photoelectric sensors are controlled by a plurality of sensor array control circuits 8 together.

The photoelectric sensors 6 and the corresponding semiconductor lasers 1 keep being gated synchronously and correspondingly, i.e., when the nth semiconductor laser is gated, the nth photoelectric sensor is gated correspondingly.

The N photoelectric sensors are located on a receiving image plane of the receiving lens group 70, and the receiving image plane of the receiving lens group 70 is considered as a plane herein and may also be non-planar. Each photoelectric sensor may receive the incident light reflected back from the target, so as to perform photoelectric conversion and effective measurement on the target.

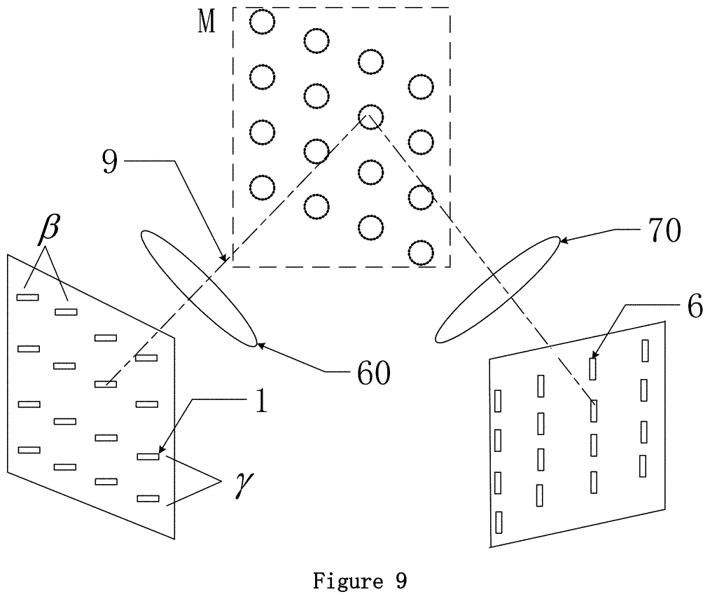

FIG. 9 shows an example view of the array laser emitting device and a projection light spot array according to a specific embodiment of the present disclosure. As a specific example, the light emitting surfaces of all the semiconductor lasers 1 (LD), i.e., the side surfaces of all the semiconductor lasers for emitting light, are arranged on an emitting focal plane of the emission lens group 60 (the emitting focal plane of the emission lens group 60 is considered as a plane herein), and the emitted laser beams of the adjacent semiconductor lasers 1 on the emitting focal plane are at an included angle β in the horizontal direction and at an included angle γ in the vertical direction.

The laser emission control module 5 triggers the driving circuit 2, such that the semiconductor lasers 1 of each channel are gated sequentially to emit the lasers. The emitted lasers are along a primary optical axis 9 of a laser emitting path, pass through the emission lens group 60, and form discrete light spots corresponding to all the laser beams at the target M, all the lasers corresponding to the discrete light spots are received by the photoelectric sensors 6 in the laser receiving device 200, and electronic control scanning array detection of a measured area is further achieved. The laser emitted by the second semiconductor laser 1 in the second row from the right is received by the second photoelectric sensor 6 of the second row from the right in FIG. 9.

Further, FIG. 8A is a schematic view of a sequential gating emitting control mode. Each semiconductor laser and the corresponding photoelectric sensor are considered as one channel, the laser emission control modules 5 controls and triggers the driving circuits sequentially, and then drive the first to the nth semiconductor lasers sequentially, thereby ensuring that the semiconductor laser emitters of all the channels emit lasers sequentially and achieving the array electronic control scanning on the detected target. According to a preset program of the laser emission control circuit, all the semiconductor lasers and all the photoelectric senses are gated in a set order, and an aim of array electronic control scanning on the detected target is achieved.

FIG. 8B shows a schematic view of a sequential gating receiving control mode. The sensor array control circuit 8 controls the laser receiving device 200 according to a preset photoelectric gating control logic 4 to be sequentially gated in the order from the first to the nth photoelectric sensor. At the same time, the laser emitting device 100 also adopts the sequential emitting order from the first to the nth semiconductor lasers. Therefore, when the nth semiconductor laser is gated, the nth photoelectric sensor is also gated.

Specifically, the N semiconductor lasers are divided into a plurality of blocks, respective block is gated sequentially in a first preset order, and respective semiconductor lasers are gated sequentially in each blocks in a second preset order.

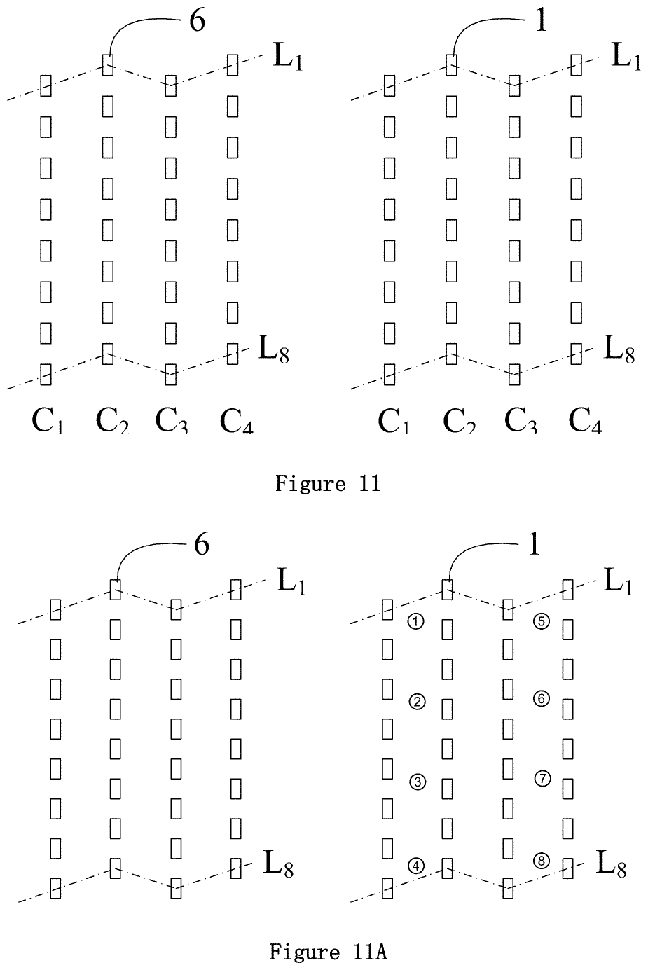

More specifically, in a first gating embodiment, the emission array has X rows and Y columns in total, and the xth semiconductor lasers of all the columns constitute a row. The xth semiconductor lasers of all the columns may be located at the same or different heights. FIG. 11 shows a schematic arrangement view of the semiconductor lasers and the photoelectric sensors, from which, the first semiconductor lasers 1 of all the columns constitute the first row L₁; in a similar fashion, the final semiconductor lasers of all the columns constitute the eighth row L₈, and the semiconductor lasers in each row may be located at the same height to constitute a straight line, and may also be located at different heights to constitute a broken line.

With regard to the laser emitting device 100 side, when the channels of the LiDAR device are gated, firstly, all the semiconductor lasers in L₁ may be gated sequentially from left to right, from right to left or in other predetermined orders, then skipping to the next row, the sequential gating step is performed in a loop, and after all the semiconductor lasers in the last row L₈ are gated, skipping to the first row L₁, until an ending signal is received. A time interval between two adjacent semiconductor lasers sequentially gated is preset, usually, is constant, and only one semiconductor laser is gated at every moment.

The gating order for rows may be L₁, L₂, . . . L₈, and other preset gating orders for rows may also be used.

With regard to the laser receiving device 200 side, the photoelectric sensors are also arranged according to the arrangement manner as shown in FIG. 11, all the photoelectric sensors are gated in a gating mode the same as that of the laser emitting device 100, such that when the nth semiconductor laser is gated, the nth photoelectric sensor is gated correspondingly, and then the channel is gated.

Similarly, in a second gating embodiment, unlike the row gating in the first gating embodiment, column gating is adopted. All the semiconductor lasers in one column are gated sequentially, skipping to the next column, and the column gating is performed in a loop. The gating order for columns may be C₁, C₂, C₃ and C₄ (see FIG. 11), and other preset gating orders for columns may also be used.

In a third gating embodiment, the odd-numbered semiconductor lasers are gated sequentially firstly, and then even-numbered semiconductor lasers are gated sequentially. For example, it is assumed that there are a total of 32 semiconductor lasers, and the gating order may be 1, 3, 5 . . . 31, 2, 4, 6 . . . 32.

That is, at step 100, the (2a+1)th semiconductor laser is gated, and then a is increased by 1 so that the step 100 is performed in a loop until 2a+1=N or 2a+1=N−1, and then a step 200 is performed, a=0, 1, 2 . . . ;

At step 200, the (2b+2)th semiconductor laser is gated, and then b is increased by 1 so that the step 200 is performed in a loop until 2b+2=N or 2b+2=N−1, b=0, 1, 2 . . . .

In a fourth gating embodiment, other block gating modes may also be adopted. For example, in FIG. 11A, every four semiconductor lasers are considered as one block, and there are in total of eight blocks in FIG. 11A.

In a first preset order, for example, an order of the 1st, 3rd, 5th, 7th, 2nd, 4th, 6th and 8th blocks, the blocks are gated sequentially. The interior of each block is gated in a clockwise, an anticlockwise, diagonal or other random orders, and the next block is gated after all the semiconductor lasers inside one block are gated.

In a fifth gating embodiment, gating is performed in a randomly-set gating order.

The gating modes based on variations of the above embodiments also fall within the disclosed scope of the present disclosure, and the gating order with high randomness has good effects in detection encryption and anti-interference.

In the LiDAR device according to the present disclosure, the corresponding semiconductor lasers are controlled in the predetermined gating mode to emit lasers, the lasers are irradiated on the target after adjusted by the emission lens group, and reflected laser signals are generated, incident on the receiving lens group as the incident light, and focused on photosensitive surfaces of the corresponding photoelectric sensors after adjusted by the receiving lens group. The sensor array control circuit 8 performs time-shared gating on the photoelectric sensors of all the corresponding channels in the predetermined gating mode, and receives echo signals returned by the projection light spots on the target, thereby achieving the reception of electric gating array scanning on the detected target.

In another embodiment of the present disclosure, the laser emitting device 100 and the laser receiving device 200 are provided at different heights.

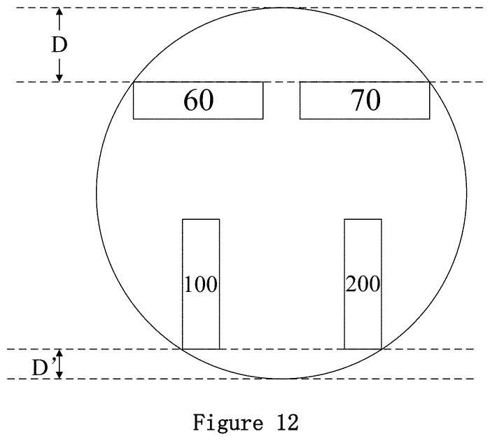

Specifically, in the embodiment shown in FIG. 3A, the laser emitting device 100 and the laser receiving device 200 are provided side by side, i.e., at the basically same height. FIG. 12 is a schematic top view of the LiDAR device according to the embodiment shown in FIG. 3A. Since a cylindrical housing is usually adopted in a LiDAR, under the premise that a distance required for light path propagation is guaranteed and space inside the housing is utilized as much as possible, the emission lens group 60, the receiving lens group 70, the laser emitting device 100 and the laser receiving device 200 are usually arranged according to FIG. 12. However, the space of areas D and D′ in the cylindrical housing may be difficult to be sufficiently used, and there is wasted space, so that the overall volume of the LiDAR device may not be reduced effectively, and it is difficult to achieve the low cost and miniaturization of the apparatus more effectively.

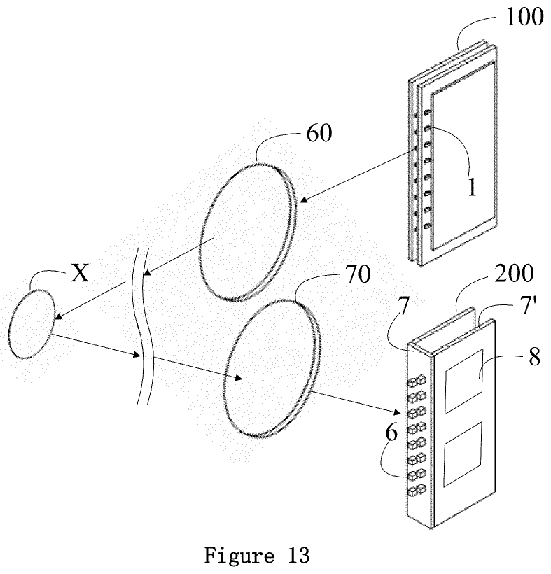

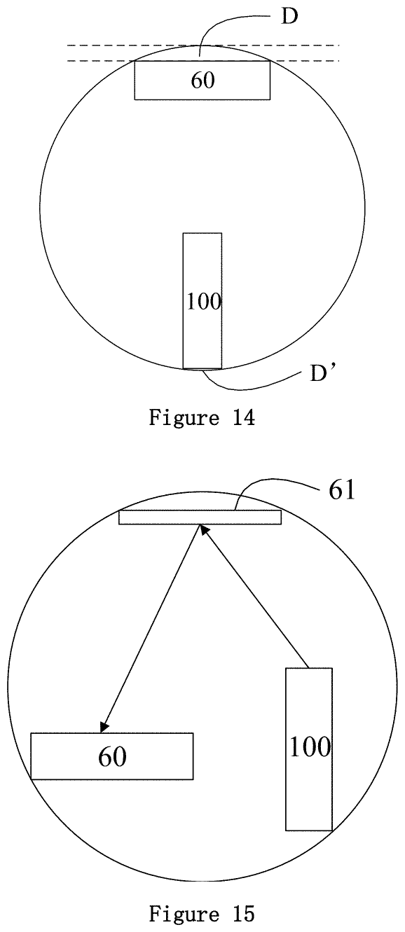

In order to effectively use the space in the LiDAR device, the volume of the LiDAR is compressed. As shown in FIG. 13, the laser emitting device 100 and the laser receiving device 200 may be provided up and down, and the emission lens group 60 and the receiving lens group 70 are also provided up and down accordingly. As shown in FIG. 14, the laser emitting device 100 is provided right above the laser receiving device 200. The emission lens group 60 is provided right above the receiving lens group 70. Since there is no need to provide two lens groups side by side, the single lens group may be provided closer to an edge of the housing, thereby further reducing the areas D and D′ in the housing close to the edge, using the space in the LiDAR device more effectively, and compressing the volume of the LiDAR.

In specific applications, the laser emitting device may be located above the laser receiving device, or the laser receiving device may be located above the laser emitting device. In addition, the laser emitting device may be located right above or in the inclined top of the laser receiving device, or the laser receiving device may be located right above or in the inclined top of the laser emitting device, so as to arrange all components conveniently, and the specific arrangement is determined based on actual demands.

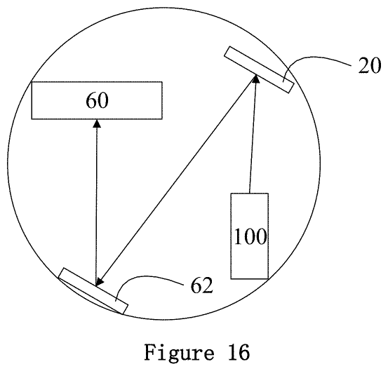

FIGS. 15 and 16 are schematic top views of the LiDAR device according to still another embodiment of the present disclosure. In order to guarantee the longer light paths, the laser emitting device may further be provided with an emission reflecting lens 61 configured for reflecting the N emergent light beams to be incident on the emission lens group 60. Or, emission reflecting lenses 61 and 62 are provided at the same time, and their specific positions are determined according to light path requirements.

A reception reflecting lens is further provided below the components shown in FIGS. 15 and 16, for reflecting the incident light to be incident on the receiving lens group 70. The reception reflecting lens is provided in the way identical to the emission reflecting lens.

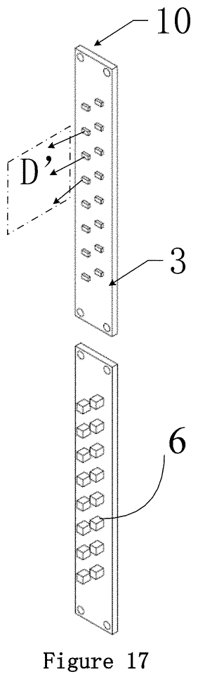

FIG. 17 shows a specific implementation of the embodiment shown in FIG. 10 when the laser emitting device 100 and the laser receiving device 200 are provided up and down.

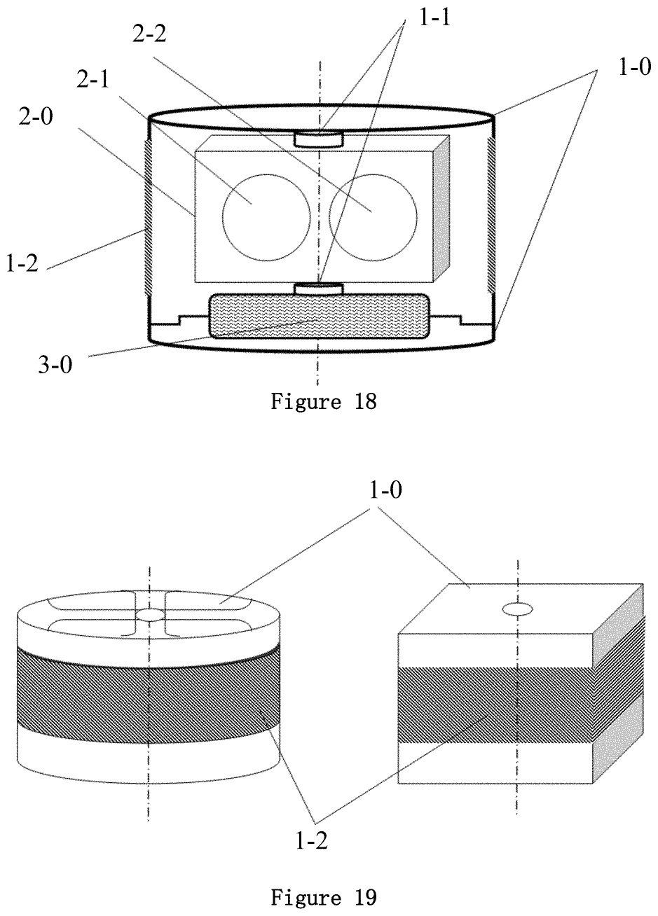

The structures of all the above-mentioned embodiments may be applied to the LiDAR device shown in FIG. 18 to achieve 360-degree scanning. The LiDAR device includes an optical-mechanical structural assembly 1-0, a laser ranging module 2-0 and a 360-degree scanning driver module 3-0, wherein

the optical-mechanical structural assembly 1-0 further includes an axis system structure 1-1, an optical window 1-2 and a housing, wherein the optical window 1-2 is provided on the housing and fully or partially covers around the axis system structure 1-1, and the axis system structure 1-1 is a rotation axis of the laser ranging module 2-0; portions of the laser ranging module 2-0 associated with the axis system structure 1-1 may be integrally machined and formed, and may also be adjusted, installed and positioned with high precision; the optical-mechanical structural assembly 1-0 is preferably of a central symmetry structure;

the laser ranging module 2-0 includes the emission lens group 60, the receiving lens group 70, the laser emitting device 100 and the laser receiving device 200 shown in FIG. 3A or FIG. 12; the emission lens group 60, the receiving lens group 70, the laser emitting device 100 and the laser receiving device 200 rotate about the axis system structure 1-1 as a whole, the emission lens group 60 and the laser emitting device 100 form the emission light path, the receiving lens group 70 and the laser receiving device 200 form the receiving light path, and both of them are designed into a parallel light path; with the design of parallel light path, receiving-emitting crosstalk may be effectively shielded, stray optical signals scattered backwards by a laser emitting assembly may be isolated, and the receiving-emitting light paths may cover close and remote fields of view at the same time;

the 360-degree scanning driver module 3-0 includes a scanning mechanism and a scanning driving and control circuit, wherein

a scanning axis of the scanning mechanism is coaxial with the axis system structure 1-1, and the scanning mechanism drives the laser ranging module 2-0 to rotate about the axis system structure 1-1 to achieve 360-degree laser scanning detection. Further, a stator part of the scanning mechanism is fixedly connected with the optical-mechanical structural assembly 1-0; a rotor part of the scanning mechanism is fixedly connected with the laser ranging module 2-0.

The optical-mechanical structural assembly 1-0 may be designed into different shapes. FIG. 19 shows a schematic view of different structural frames of the optical-mechanical structural assembly 1-0 according to the embodiment of the present disclosure. The optical-mechanical structural assembly 1-0 in FIG. 19 has a structure of a cylinder or circular truncated cone or cube frame, and correspondingly, the optical window 1-2 is also designed into different shapes according to the form of the optical-mechanical structural assembly 1-0.

Further, besides the above-mentioned shapes, the optical-mechanical structural assembly may also be of a frame structure with a quadrangular or polygonal cross section; the above-mentioned optical-mechanical structural assembly 1-0 forms a sealing structure for the whole LiDAR device.

The device according to the present disclosure has a high integration level and a small volume, and is applied to LiDAR autonomous vehicles, robot navigation, obstacle avoidance, or the like; meanwhile, with the design of parallel light path, the receiving-emitting crosstalk may be effectively shielded, the stray optical signals scattered backwards by the laser emitting assembly may be isolated, and the receiving-emitting light paths may cover close and remote fields of view at the same time.

In summary, the present disclosure discloses a LiDAR device, including: a laser emitting device which has N semiconductor lasers arranged in an emission array, for emitting N emergent light beams, the N semiconductor lasers being provided on M emission circuit boards of the laser emitting device, and M being less than N; an emission lens group, configured for adjusting angles of the N emergent light beams; a receiving lens group, configured for adjusting an angle of incident light; and a laser receiving device, having N photoelectric sensors arranged into a receiving array, for receiving the incident light adjusted by the receiving lens group; wherein the position of the nth semiconductor laser in the emission array is equal to that of the nth photoelectric sensor in the receiving array, n=1, 2 . . . N, N is a positive integer, M is a positive integer, and the emission lens group and the receiving lens group have corresponding light paths, such that the emergent light emitted by the nth semiconductor laser is reflected off a target and then incident on the nth photoelectric sensor.

In some embodiments of the disclosure, the laser emitting device and the laser receiving device are provided at the same or different heights.

In some embodiments of the disclosure, the laser emitting device is located right above or in the inclined top of the laser receiving device, or the laser receiving device is located right above or in the inclined top of the laser emitting device.

In some embodiments of the disclosure, the laser emitting device may further includes: one or more laser emitting modules, including a vertically-placed emission circuit board, a plurality of said semiconductor lasers and a driving circuit, wherein the plurality of said semiconductor lasers are placed on the emission circuit board, the driving circuit is connected with the plurality of said semiconductor lasers to drive the plurality of said semiconductor lasers to emit light, and a light outgoing surface consisting of light outgoing directions of the plurality of said semiconductor lasers is parallel to the emission circuit board; and a laser emission control module, connected with the laser emitting modules to control the driving circuit to drive the corresponding semiconductor lasers to emit light.

In some embodiments of the disclosure, a plurality of emission circuit boards of a plurality of laser emitting modules are provided side by side, and the plurality of the semiconductor lasers are placed at an edge of one side of the emission circuit board; or a plurality of emission circuit boards of a plurality of laser emitting modules are divided into a plurality of rows provided side by side, and the plurality of said semiconductor lasers are placed at an edge of one side of the emission circuit board.

In some embodiments of the disclosure, the laser emitting device further includes: at least one laser emitting module, including a vertically-placed emission circuit board, the N semiconductor lasers and a driving circuit, wherein the N semiconductor lasers are placed on the emission circuit board, the driving circuit is connected with a plurality of said semiconductor lasers to drive the plurality of said semiconductor lasers to emit light, and a light outgoing surface consisting of light outgoing directions of each column in the emission array is perpendicular to the emission circuit board; and

a laser emission control module, connected with the laser emitting module, to control the driving circuit of the laser emitting module to drive the corresponding semiconductor lasers to emit light.

In some embodiments of the disclosure, the laser emitting module has one or more driving circuits, each of which drives one or more said semiconductor lasers.

In some embodiments of the disclosure, the laser emission control module is provided on the emission circuit board, or the laser emission control module is provided on a control circuit board, and the control circuit board is connected to the emission circuit board through a connector.

In some embodiment of the disclosure, any two emergent light beams adjusted by the emission lens group have different directions.

In some embodiments of the disclosure, the laser receiving device includes: N photoelectric sensor units, each including the photoelectric sensor and a peripheral circuit thereof; a vertically-placed receiving circuit board, on which the N photoelectric sensors are provided; and a sensor array control circuit, configured for controlling gating of the N photoelectric sensors.

In some embodiments of the disclosure, light emitting surfaces of the N semiconductor lasers are located on a focal plane of the emission lens group, and the N photoelectric sensors are located on a receiving image plane of the receiving lens group.

The present disclosure further discloses a channel gating method applied to the above mentioned LiDAR device, including: gating N semiconductor lasers sequentially in a set order, and gating the nth photoelectric sensor correspondingly when the nth semiconductor laser is gated.

In some embodiments of the disclosure, the method may further includes: dividing the N semiconductor lasers into a plurality of blocks, sequentially gating each of the blocks in a first preset order, and sequentially gating each of the semiconductor lasers in each of the blocks in a second preset order.

In some embodiments of the disclosure, the method may further includes: step 1, at which, each of the semiconductor lasers in the xth row in the emission array are gated sequentially, the emission array having X rows and Y columns in total, the xth semiconductor lasers of all the columns constituting a row, x=1, 2 . . . X, and both X and Y being positive integers; step 2, at which, x is increased by 1, and the step 1 is continuously performed; or, the method further includes: step 10, at which, each of the semiconductor lasers in the yth column in the emission array are gated sequentially, the emission array having X rows and Y columns in total, the xth semiconductor lasers of all the columns constituting a row, y=1, 2 . . . Y, and both X and Y being positive integers; step 20, at which, y is increased by 1, and the step 10 is continuously performed; or, the method further includes: step 100, at which, the (2a+1)th semiconductor laser is gated, and then a is increased by 1, the step 100 is performed in a loop until 2a+1=N or 2a+1=N−1, a=0, 1, 2 . . . ; then a step 200 is performed; step 200, at which, the (2b+2)th semiconductor laser is gated, and then b is increased by 1, the step 200 is performed in a loop until 2b+2=N or 2b+2=N−1, b=0, 1, 2 . . . .

The present disclosure further discloses a LiDAR device, including an optical-mechanical structural assembly, a laser ranging module and a 360-degree scanning driver module, wherein the optical-mechanical structural assembly further includes an axis system structure and an optical window, and the axis system structure is a rotation axis of the laser ranging module; the laser ranging module includes an emission lens group, a receiving lens group, a laser emitting device and a laser receiving device; the 360-degree scanning driver module includes a scanning mechanism and a scanning driving and control circuit, a scanning axis of the scanning mechanism is coaxial with the axis system structure, and the scanning mechanism drives the laser ranging module to rotate about the axis system structure to achieve 360-degree laser scanning detection; the laser emitting device has N semiconductor lasers arranged in an emission array, for emitting N emergent light beams, the N semiconductor lasers are provided on M emission circuit boards of the laser emitting device, and M is less than N; the emission lens group is configured for adjusting angles of the N emergent light beams; the receiving lens group is configured for adjusting an angle of incident light; and the laser receiving device has N photoelectric sensors arranged in a receiving array, for receiving the incident light adjusted by the receiving lens group; the position of the nth semiconductor laser in the emission array is equal to that of the nth photoelectric sensor in the receiving array, n=1, 2 . . . N, N is a positive integer, M is a positive integer, and the emission lens group and the receiving lens group have corresponding light paths, such that the emergent light emitted by the nth semiconductor laser is reflected by a target and then incident on the nth photoelectric sensor.

In some embodiments of the disclosure, the laser emitting device and the laser receiving device are provided at the same or different heights.

In some embodiments of the disclosure, the laser emitting device may further includes: one or more laser emitting modules, including a vertically-placed emission circuit board, a plurality of said semiconductor lasers and a driving circuit, wherein the plurality of semiconductor lasers are placed on the emission circuit board, the driving circuit is connected with the plurality of said semiconductor lasers to drive the plurality of said semiconductor lasers to emit light, and a light outgoing surface consisting of light outgoing directions of the plurality of said semiconductor lasers is parallel to the emission circuit board; and a laser emission control module, connected with the laser emitting modules, to control the driving circuit to drive the corresponding semiconductor lasers to emit light;

In some embodiments of the disclosure, the laser emitting device may further includes: at least one laser emitting module, including a vertically-placed emission circuit board, the N semiconductor lasers and a driving circuit, wherein the N semiconductor lasers are placed on the emission circuit board, the driving circuit is connected with a plurality of said semiconductor lasers to drive the plurality of said semiconductor lasers to emit light, and a light outgoing surface consisting of light outgoing directions of each column in the emission array is perpendicular to the emission circuit board; and a laser emission control module, connected with the laser emitting module to control the driving circuit of the laser emitting module to drive the corresponding semiconductor lasers to emit light.

In some embodiments of the disclosure, the optical-mechanical structural assembly has a shape of a cylinder, a circular truncated cone or a cube.

The present disclosure has concise mounting process, high efficiency and high yield, thus is suitable for mass production. Meanwhile, in the present disclosure, by means of circuit integration and electronic control scanning, array laser emitting devices are integrated and miniaturized, a size and the weight of the system are reduced, and the low cost and miniaturization of the apparatus may be achieved. An up-and-down arrangement may further compress the volume of the LiDAR device to realize light and small LiDAR devices.

### INDUSTRIAL APPLICABILITY

In the present disclosure, the mounting process is concise, the efficiency is high, the yield is high, and mass production is easy to realize. With the electric gating control over the array photoelectric sensors, the sequential gating or parallel gating of the array photoelectric sensors is achieved, a receiving flexibility and a receiving capacity of the space target detection are improved, the electronic control scanning array detection of the target is achieved, the integration level of the system is increased, the detection target receiving efficiency is improved, and the miniaturization of the system is easy to realize.

What is claimed is:

1. A LiDAR device, comprising:
a laser emitting device, having N semiconductor lasers arranged in an emission array for emitting N emergent light beams, the N semiconductor lasers being provided on M emission circuit boards of the laser emitting device, and M being less than N;
an emission lens group, configured for adjusting angles of the N emergent light beams;
a receiving lens group, configured for adjusting an angle of incident light; and
a laser receiving device, having N photoelectric sensors arranged into a receiving array, for receiving the incident light adjusted by the receiving lens group;
wherein the position of the nth semiconductor laser in the emission array is equal to that of the nth photoelectric sensor in the receiving array, n=1, 2 . . . N, N is a positive integer, M is a positive integer, and the emission lens group and the receiving lens group have corresponding light paths, such that the emergent light emitted by the nth semiconductor laser is reflected off a target and then incident on the nth photoelectric sensor.

2. The device according to claim 1, wherein the laser emitting device and the laser receiving device are provided at the same or different heights.

3. The device according to claim 2, wherein the laser emitting device is located right above or in the inclined top of the laser receiving device, or the laser receiving device is located right above or in the inclined top of the laser emitting device.

4. The device according to claim 1, further comprising:
one or more laser emitting modules, the laser emitting module comprising a vertically-placed emission circuit board, a plurality of said semiconductor lasers and a driving circuit, wherein the plurality of said semiconductor lasers are placed on the emission circuit board, the driving circuit is connected with the plurality of said semiconductor lasers to drive the plurality of said semiconductor lasers to emit light, and a light outgoing surface consisting of light outgoing directions of the plurality of said semiconductor lasers is parallel to the emission circuit board; and
a laser emission control module, connected with the laser emitting modules to control the driving circuit to drive the corresponding semiconductor lasers to emit light.

5. The device according to claim 4, wherein a plurality of emission circuit boards of a plurality of laser emitting modules are provided side by side, and the plurality of said semiconductor lasers are placed at an edge of one side of the emission circuit board;
or a plurality of emission circuit boards of a plurality of laser emitting modules are divided into a plurality of rows provided side by side, and the plurality of said semiconductor lasers are placed at an edge of one side of the emission circuit board.

6. The device according to claim 1, further comprising:
at least one laser emitting module, the laser emitting module comprising a vertically-placed emission circuit board, the N semiconductor lasers and a driving circuit, wherein the N semiconductor lasers are placed on the emission circuit board, the driving circuit is connected with a plurality of said semiconductor lasers to drive the plurality of said semiconductor lasers to emit light, and a light outgoing surface consisting of light outgoing directions of each column in the emission array is perpendicular to the emission circuit board; and
a laser emission control module, connected with the laser emitting module to control the driving circuit of the laser emitting module to drive the corresponding semiconductor lasers to emit light.

7. The device according to claim 4, wherein the laser emitting module has one or more said driving circuits, each of which drives one or more semiconductor lasers.

8. The device according to claim 6, wherein the laser emitting module has one or more said driving circuits, each of which drives one or more semiconductor lasers.

9. The device according to claim 4, wherein the laser emission control module is provided on the emission circuit board, or the laser emission control module is provided on a control circuit board, and the control circuit board is connected to the emission circuit board through a connector.

10. The device according to claim 6, wherein the laser emission control module is provided on the emission circuit board, or the laser emission control module is provided on a control circuit board, and the control circuit board is connected to the emission circuit board through a connector.

11. The device according to claim 1, wherein any two emergent light beams adjusted by the emission lens group have different directions.

12. The device according to claim 1, wherein the laser receiving device comprises:
N photoelectric sensor units, each comprising the photoelectric sensor and a peripheral circuit thereof;
a vertically-placed receiving circuit board, on which the N photoelectric sensors are provided;
a sensor array control circuit, configured for controlling gating of the N photoelectric sensors.

13. The device according to claim 1, wherein light emitting surfaces of the N semiconductor lasers are located on a focal plane of the emission lens group, and the N photoelectric sensors are located on a receiving image plane of the receiving lens group.

14. A channel gating method applied to the LiDAR device according to claim 1, comprising:
gating the N semiconductor lasers sequentially in a set order, and gating an nth photoelectric sensor correspondingly when the nth semiconductor laser is gated.

15. The method according to claim 14, further comprising:
dividing the N semiconductor lasers into a plurality of blocks, sequentially gating each of the blocks in a first preset order, and sequentially gating each of the semiconductor lasers in each of the blocks in a second preset order.

16. The method according to claim 14, further comprising:
step 1, at which, each of the semiconductor lasers in the xth row in the emission array are gated sequentially, the emission array having X rows and Y columns in total, the xth semiconductor lasers of all the columns constituting a row, x=1, 2 . . . X, and both X and Y being positive integers;
step 2, at which, x is increased by 1, and the step 1 is continuously performed;
or, the method further comprises:
step 10, at which, each of the semiconductor lasers in the yth column in the emission array are gated sequentially, the emission array having X rows and Y columns in total, the xth semiconductor lasers of all the columns constituting a row, y=1, 2 . . . Y, and both X and Y being positive integers;
step 20, at which, y is increased by 1, and the step 10 is continuously performed;
or, the method further comprises:
step 100, at which, the (2a+1)th semiconductor laser is gated, and then a is increased by 1, the step 100 is performed in a loop until 2a+1=N or 2a+1=N−1, a=0, 1, 2 . . . Then a step 200 is performed;
step 200, at which, the (2b+2)th semiconductor laser is gated, and then b is increased by 1, the step 200 is performed in a loop until 2b+2=N or 2b+2=N−1, b=0, 1, 2 . . . .

17. A LiDAR device, comprising an optical-mechanical structural assembly, a laser ranging module and a 360-degree scanning driver module, wherein
the optical-mechanical structural assembly further comprises an axis system structure and an optical window, and the axis system structure is a rotation axis of the laser ranging module;
the laser ranging module comprises an emission lens group, a receiving lens group, a laser emitting device and a laser receiving device;
the 360-degree scanning driver module comprises a scanning mechanism and a scanning driving and control circuit, a scanning axis of the scanning mechanism is coaxial with the axis system structure, and the scanning mechanism drives the laser ranging module to rotate about the axis system structure to achieve 360-degree laser scanning detection;
the laser emitting device has N semiconductor lasers arranged in an emission array for emitting N emergent light beams, the N semiconductor lasers are provided on M emission circuit boards of the laser emitting device, and M is less than N;
the emission lens group is configured for adjusting angles of the N emergent light beams;
the receiving lens group is configured for adjusting an angle of incident light; and
the laser receiving device has N photoelectric sensors arranged in a receiving array for receiving the incident light adjusted by the receiving lens group;
wherein the position of the nth semiconductor laser in the emission array is equal to that of the nth photoelectric sensor in the receiving array, n=1, 2 . . . N, N is a positive integer, M is a positive integer, and the emission lens group and the receiving lens group have corresponding light paths, such that the emergent light emitted by the nth semiconductor laser is reflected off a target and then incident on the nth photoelectric sensor.

18. The device according to claim 17, wherein the laser emitting device and the laser receiving device are provided at the same or different heights.

19. The device according to claim 17, further comprising:
one or more laser emitting modules, comprising a vertically-placed emission circuit board, a plurality of said semiconductor lasers and a driving circuit, wherein the plurality of said semiconductor lasers are placed on the emission circuit board, the driving circuit is connected with the plurality of said semiconductor lasers to drive the plurality of said semiconductor lasers to emit light, and a light outgoing surface consisting of light outgoing directions of the plurality of said semiconductor lasers is parallel to the emission circuit board; and
a laser emission control module, connected with the laser emitting modules to control the driving circuit to drive the corresponding semiconductor lasers to emit light;
or the laser emitting device further comprises:
at least one laser emitting module, comprising a vertically-placed emission circuit board, the N semiconductor lasers and a driving circuit, wherein the N semiconductor lasers are placed on the emission circuit board, the driving circuit is connected with a plurality of said semiconductor lasers to drive the plurality of said semiconductor lasers to emit light, and a light outgoing surface consisting of light outgoing directions of each column in the emission array is perpendicular to the emission circuit board; and
a laser emission control module, connected with the laser emitting module to control the driving circuit of the laser emitting module to drive the corresponding semiconductor lasers to emit light.

20. The device according to claim 17, wherein
the optical-mechanical structural assembly has a shape of a cylinder, a circular truncated cone or a cube.
